(19) United States
(12) Patent Application Publication
(10) Pub. No.: US 2012/0323775 A1
(43) Pub. Date: Dec. 20, 2012

(54) ENHANCED SEARCHABILITY OF FIELDS ASSOCIATED WITH ONLINE BILLPAY MEMO DATA

(75) Inventors: Howard O. Weinstein, Boston, MA (US); William E. Thomas, Charlotte, NC (US); Daniel M. Whipple, Charlotte, NC (US); Christopher Hope, Charlotte, NC (US); Savit A. Pirl, Bolingbrook, IL (US)

(73) Assignee: Bank of America, Charlotte, NC (US)

(21) Appl. No.: 13/218,607

(22) Filed: Aug. 26, 2011

Related U.S. Application Data
(60) Provisional application No. 61/496,929, filed on Jun. 14, 2011.

(51) Int. Cl. G06Q 40/00; G06F 17/30

(52) U.S. Cl. 705/40

(57) ABSTRACT

Apparatus and methods for improving online bill payment processes are provided. Online bill payment typically involves a paying party (“payor”), an intermediary (such as a bank, a billpay service or a billpay network) and a payee. In some embodiments, the apparatus and methods may provide optional file attachments that may be communicated from a payor (initiator) to a payee (recipient). Such attachments might include a signed contract for products or services, a payment stub with descriptive details of the payment, a photo of an item being purchased, or any other document that the payor wishes to send in connection with the payment transaction. The field(s) associated with the attachment may be searchable. Such fields may be searchable by a characteristic of the attachment. Characteristics may include content of the attachment of an electronic format of the attachment.

### CROSS-REFERENCE TO RELATED APPLICATION

This application is a nonprovisional of U.S. Provisional Application No. 61/496,929 filed on Jun. 14, 2011 which is hereby incorporated by reference in its entirety.

### FIELD OF TECHNOLOGY

Aspects of the disclosure relate to searchability of an attachment of electronic documents to online bill payment records.

### BACKGROUND

Online bill payment (“billpay”) has become a common capability in banks and other financial institutions that offer e-commerce websites. Typically, an internet website platform is used to facilitate payment, by a payor to a payee, of bills and debts. Payors and payees may include consumers, small business customers and others. Billpay may encompass payment of bills, debts and other monetary transactions.

Payments may be effected by paper or electronic check, electronic fund transfer, third party payment network such as the Automated Clearinghouse (“ACH”), general ledger transfer in a closed-loop payments network such as PayPal®, or through other electronic means for effecting fund transfer between parties.

An attachment may be appended to a transaction using apparatus and methods shown and described in co-pending, commonly assigned U.S. patent application Ser. No. 12/193,947 entitled “Online Billpay Payment Attachments,” which is hereby incorporated herein by reference in its entirety.

If an attachment is appended to a transaction, searchability of the attachment may provide access to historic records of electronic payment attachments or payment details. Searchability of an attachment may provide an efficient and logical approach to organization of electronic payments.

It would be desirable, therefore, to provide apparatus and methods for enhanced searchability of online billpay records and attachments.

### SUMMARY OF THE DISCLOSURE

It is an object of this invention to provide apparatus and methods for enhanced searchability of attachments to online billpay records.

The apparatus and methods may involve receiving an electronic request from the payor. The request may be a request to transmit funds to the payee. The payor may attach a data object to an electronic record associated with the transaction.

The attachment may be an electronic file, an electronic folder, or any other suitable data structure. The attachment may be formatted as an image, text, audio, video or any other suitable format. The attachment may be stored in a database.

The attachment may be searchable by the payee and/or payor. As such, the payee and/or payor may search for an electronic file, electronic file folder and/or other electronic storage area for a historic record of an electronic payment or attachment. A search may be conducted based on a characteristic of the attachment.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a schematic diagram of apparatus that may be used in accordance with the principles of the invention;

FIG. 2 is a schematic diagram of other apparatus that may be used in accordance with the principles of the invention;

FIG. 3 is a flow diagram that shows a process in accordance with the principles of the invention;

FIG. 4 is a flow diagram that shows a process that corresponds to a portion of the process shown in FIG. 3;

FIG. 5 is a flow diagram that shows another process that corresponds to a portion of the process shown in FIG. 3;

FIG. 6 is a flow diagram that shows yet another process that corresponds to a portion of the process shown in FIG. 3; and

FIG. 7 is a flow diagram that shows still another process that corresponds to a portion of the process shown in FIG. 3.

### DETAILED DESCRIPTION OF THE DISCLOSURE

Apparatus and methods for improving online bill payment processes are provided. Apparatus and methods may provide enhanced searchability of an electronic transaction between a payor and a payee.

Online bill payment typically involves a paying party (“payor”), an intermediary (such as a bank, a billpay service or a billpay network) and a payee. In some embodiments, the apparatus and methods may provide a capability for an optional file attachment to be communicated from a payor (initiator) to a payee (recipient).

Such an attachment may include a signed contract for products or services, a payment stub with descriptive details of the payment, a photo of an item being purchased, or any other document that the payor wishes to send in connection with the payment transaction. In some embodiments, the data to be passed from payor to payee with the payment could be comprised of one or more text/comment fields.

An attachment may take the form of an electronic file. The file may be uploaded to a payment intermediary, such as a bank, a billpay service, a billpay network, or any other suitable intermediary. The attachment may originate as a file from the payor's computer, a scan from a scanner, a fax, a photo, an audio and/or video recording, or any other means of electronic document capture.

Embodiments may provide searchability of a characteristic of the electronic file attachment appended to the transaction. The attachment may be searchable based on a characteristic of the transaction and/or an associated attachment. Characteristics of an attachment that may be searchable are described below.

### Searchability Based on Payment Details

An attachment may be searchable by payment details. Payment details may be searchable by the payee and/or payor. As such, the payee and/or payor may search for an electronic file, electronic file folder and/or other electronic storage area for historic electronic payment attachments.

Payment details may include an amount of the payment, payor, payee, an address a date/time or any other detail included in the payment.

For example, an attachment may be searchable based on a time and/or date the attachment is appended to a transaction. A search may be conducted for an attachment based on a time the transaction was submitted by a payor.

The attachment may be searchable based on when funds of the associated transaction are/will be/were made available to a payee.

### Searchability Based on Contents of an Electronic File

An attachment associated with a transaction may include information that the payor selects. The information may relate to the transaction, terms of the transaction, prior communications between the payor and the payee, prior communications among the payor, the payee and a third party. The attachment may be any suitable data object such as an electronic file, an electronic folder, or any other suitable data structure. The attachment may be formatted as an image, text, audio, video or any other suitable format.

The format of an attachment may be indicated by an extension appended to a name of an electronic file. An attachment may be in any suitable data format, such as DOC, PDF, TIFF, WAV, MP3, or JPEG. A search may be conducted for an attachment with a particular extension or format such as DOC, PDF, TIFF, WAV, MP3, or JPEG.

Embodiments may provide that contents of an attachment may be searchable. For example, if the attachment includes an image, a search may be conducted based on a distinctive data pattern exemplifying the image. A search may be conducted for transactions associated with attachments that contain a particular image pattern.

In some embodiments, an attachment may include a text field. The text field may be keyword searchable. For example, if a payor made numerous tax payments including attachments such as an IRS estimated payment voucher, the vouchers may be searchable by a text field of the voucher. Such an exemplary text field may include the term “tax voucher” or other relevant statement.

In another example, an attachment may be a fillable PDF. Such a PDF may include identifiers associated with certain fillable fields. Such identifiers may also be searchable. Accordingly, a file folder containing payment attachments may be searchable according to what fillable fields, or other fields exist, in the fillable PDFs.

In some embodiments, an attachment may be searchable based on the content irrespective of a specific text field. A search may be conducted based on a string or characters or keyword contained anywhere within the attachment.

In some embodiments, a file name of an attachments may be searchable. For example, if a user had made numerous tax payments using attachments including an IRS estimated payment voucher, the file names of each of the attachments may include the term, “March2011tax_voucher.pdf.” A keyword search for the term “voucher” of an electronic file of attachment names may retrieve all attachments including the term “voucher.” The search may be limited to a certain period of time.

Some embodiments may provide searchability based on the number of files included as attachments. For example, if the attachment includes a signed contract and a photo of an item being purchased, a search may be conducted for transactions associated with two file attachments.

### Searchability Based on an Associated Location

The attachment may be searchable based on a location associated with the attachment. For example, a search may be conducted for an attachment based on a geographic location where the attachment was associated with the transaction. The location where the attachment was associated with the transaction may include the physical location of a device used by the payor to append the attachment to the transaction or a device used to perform an electronic document capture.

A location may include a physical location of a payor, payee, intermediary or their respective principal place of business. A location may include the location of an electronic file on a computer readable storage medium.

A location may be identified by GPS coordinates, longitude/latitude coordinates or any other suitable geographic marker.

### Searchability Based on a Source of an Electronic File

Searchability may be based on the source of an electronic file. If an attachment originated as a file from the payor's computer, the source of the file may be stored. A search may be conducted for files that originated from a particular source. The source may be a device such as a computer or scanner or any device used as a means of electronic document capture.

In some embodiments, an identification number of a source device may be stored within the attachment. The identification number may be searchable. An identifier may include a MAC address, IP address or any suitable identifier.

### Searchability Based on Attachment Parameters

In some embodiments, the payment intermediary may set limits on the attachment, such as size, file type, etc. The intermediary may scan the attachment for malware or inappropriate content to prevent intentional or unintentional dispersion of malicious software code, digital rights violations, or harassing images or content.

A search may be conducted based on the limits imposed by the intermediary. For example, a search may be conducted for transactions having a particular size or limited to a particular size. A search may be conducted for attachments and/or associated transactions that have been scanned for malware or inappropriate content. A search may be conducted based on results of the scan for malware or inappropriate content.

### Searchability Based on Payor/Payee Properties

An attachment associated with a transaction may be made available to the payee whether or not the payee is a customer or member of the payment intermediary (financial institution, bank, network, or otherwise) and whether the payment was made electronically (e.g., by Automated Clearing House (“ACH”) or other method) or by paper (check, draft, etc.)

A search may be conducted based on whether or not the payee is a customer of a payment intermediary. A search may be conducted based on membership of the payee in a payment intermediary. For example, a payor may submit payment requests to multiple payees, and each payee may be a member of a different bank. The payor may conduct a search for attachments associated with a payment request submitted to a specific bank.

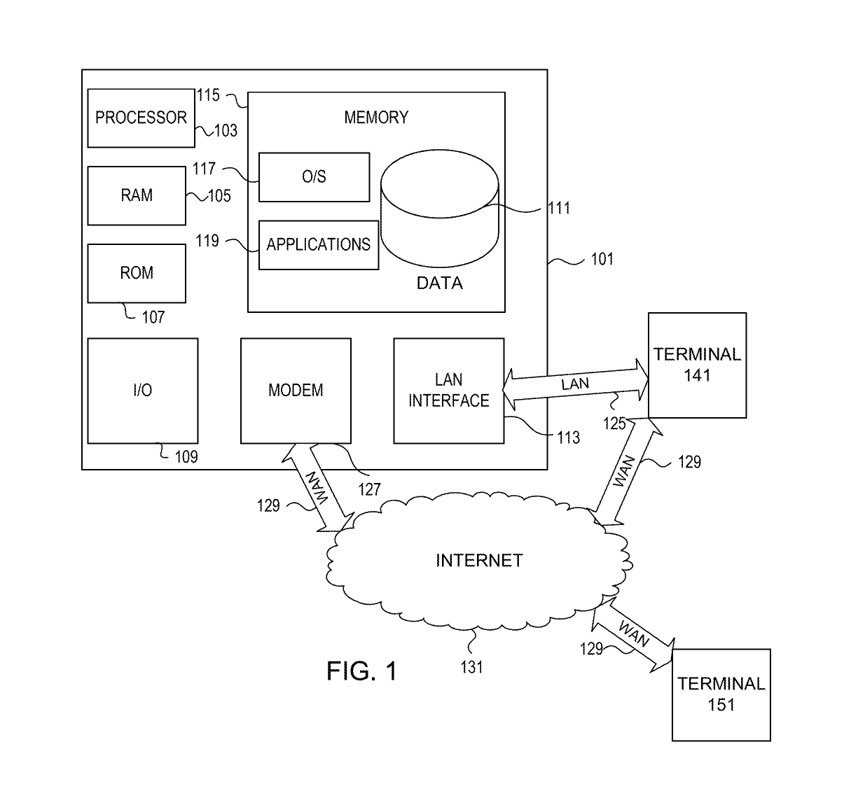

In the case of an electronic payment, the payee may be provided with a preferably secure link that would enable the payee to view or download the attachment. In the case of paper payment, the payee may be provided with instructions and a file-code or link-name that if entered into an internet accessible computer terminal (see FIG. 1, item 151) would enable the payee to view or download the attachment. Whether a payment is in paper or electronic form, the payee may be provided with a paper copy of the attachment.

A search may be conducted based on whether a secure link was transmitted to a payee. A search may be conducted based on whether a paper copy of an attachment was provided to a payee. A date and/or time when an attachment was transmitted to a payee may be used as a search criterion.

An attachment may be made available for retrieval via a two-step or three-step process as detailed below.

In the two-step attachment/notification process, the first step may be that a payor attaches the attachment to a payment. The second step may be that the intermediary notifies the payee about the attachment.

The two-step attachment/notification may provide notice to the payee that the payor has made a payment that is substantiated, qualified, conditioned or otherwise modified. The three-step attachment/notification may be useful for giving the payor notice that the payee has accessed the attachment. This may give the payor an opportunity, for example, to timely contact the payee to resolve shipment or billing disputes.

The three-step attachment/notification process is similar to the two-step attachment/notification process, but may include, as a third step, that the intermediary notifies the payor that the payee has viewed or retrieved a copy of the attachment.

In some embodiments, a search may be conducted based on whether the two-step or three-step attachment/notification process is to be used in conjunction with the transaction.

The notification may be executed by any suitable paper or electronic communication, including postal letter, electronic mail, text message, telephone, fax or any other suitable communication. The notification may be automatically stored in a database for future reference.

In some embodiments, the payor and/or the payee may set preferences regarding the notifications. Such preferences may include whether a notification is received at all and/or whether to selectively receive a notification. Criteria for selectively receiving a notification may be based on parameters such as a size of transaction, merchant and/or type of transaction.

Another preference regarding the reporting of the notifications may include when or at what intervals the notifications are provided. For example, the notifications may be provided in real time or in a batch processing format at some predetermined interval.

Another preference regarding the reporting of the notifications may include whether or not indications, such as confirmation of receipt by the payee, are provided to the payor when reviewing a transaction history or statement and whether such information is reported in detailed or summary formats.

A search for a transaction/attachment may be conducted based on a notification preference. One may search for any transaction/attachment that has a notification preference that requires a notification be sent at some predetermined interval. One may search for a transaction based on whether information is reported in summary or detailed format.

In some embodiments, the intermediary may provide to both the payor and the payee the capability to view, print, save, and/or send an attachment related to a payment. A search may be conducted based on action taken in response to a notification. For example, a search may be conducted based on whether the attachment has been printed, saved or viewed.

In some embodiments of the invention, a file folder may be configured to receive electronic responses to payments, automated or otherwise. Preferably, the responses to payments should be associated with the payment to which it corresponds. Such association may be implemented using identifiers in the responses.

A search may be conducted based on a response to a payment. For example, a search may be conducted for transactions/attachments with a threshold number of associated responses.

### Searchability Based on Electronic Data Interchange (“EDI”) Properties

In some embodiments, the apparatus and methods may be used in connection with Electronic Data Interchange (“EDI”) platforms and the like. Typically, a financial institution (such as a bank) may receive billpay instructions from a large number of its customers to pay a single payee (such as a credit card company) that is common to all of the payors.

EDI-based transactions enable the financial institution to pay the common payee by transmitting to the payee a single sum of funds along with a list that identifies the payors, the individual payment amounts to be credited to the payors' accounts and any appropriate supporting information. When the common payee receives the sum, it allocates the sum among the payors' accounts.

The invention may provide apparatus and methods by which an individual payor may attach information to a billpay record that will be incorporated into an EDI-based transaction. In some embodiments, billpay attachments from the payors may be transmitted as an electronic “bundle” of attachments. The attachments may be transmitted together with, or separately from, the list of payor identifiers. The financial institution may provide to the payee cross-reference information that links a payor, or a payor account, to a corresponding attachment.

EDI standards were developed by the American National Standards Institute (ANSI) to promote electronic commerce. EDI standards for numerous types of transactions are available. For example, EDI standards are available for purchase orders and invoices. In EDI, all data field names, types, formats, lengths and other data parameters are defined in a data dictionary. EDI platforms may be used by billpay organizations to serve their clients. In the context of the financial services industry, a bank, for example, may be the billpay (or intermediary) organization. A payor may be, for example, a client, customer or account holder of the bank. A payee may be a trading partner of the client. Clients and trading partners may be individuals, organizations, business or government entities. The use of EDI with the invention is set forth in more detail below.

EDI platforms typically communicate at the system-to-system level using structured data. EDI platforms may support the processing of data in any suitable format, such as ANSI X12, CEFACT and EDIFACT. EDI platform data may be translated for interfacing with any suitable accounting systems, such as accounts payable and accounts receivable systems.

In some embodiments of the invention, the apparatus may be used in connection with e-commerce systems. An e-commerce system may operate at different levels. Some are system-to-system. Some are people-to-system. Some are people-to-people. An e-commerce system may support the use of structured or unstructured data. An e-commerce system may support the use of data in any suitable format. For example, e-commerce systems may support the use of EDI data, XML data or any other suitable type of data. An e-commerce system may be part of any suitable commerce system, such as a financial supply chain management system (enterprise resource planning (“ERP”) systems, for example).

Transaction intermediaries using EDI or another platform may process a large volume of payment instructions from a single client. The instructions may be combined into a single electronic file. The payments may be made to domestic payees, foreign payees or both. The payments may include domestic wires, international wires, including Bulk FX wire, or both domestic and foreign wires. The payments may be effected by domestic check or draft, international check or draft. The checks and drafts may be printed in any suitable language.

EDI platforms are compatible with numerous billpay modules, numerous client transmission platforms, and client internal systems. Table 1 shows exemplary EDI-compatible formats in connection with which the apparatus and methods of the invention may be used to attach a data object to an electronic transaction record.

TABLE 1
Illustrative Payment Network Origination Module Formats

| Format | Illustrative usage |
|---|---|
| X12 - 820 | Payment Order/Remittance Advice |
| X12 - 835 | Health Care Claim Payment/Advice |
| X12 - 831 | Control Totals |
| X12 - 828 | Debit Authorization (Checks Issued |
| EDIFACT - | PAYEXT Extended Payment Order Message |
| EDIFACT - | DIRDEB Direct Debit Message |
| SAP IDOC | SAP Intermediate Document |
| TD-CPA | (Canadian ACH payments) |
| FIRM - | Japanese Low-Value Clearing (Zengin) |
| CSV - | Comma Delimited |
| XML | |

Table 2 shows exemplary EDI-compatible client transmission platforms in connection with which the apparatus and methods of the invention may be used to attach a data object to an electronic transaction record.

TABLE 2
Illustrative Client Transmission Platforms
Client Transmission Platforms

VAN (Value Added Network)
DTS (Data Transmission Support)
Swift FileACT
GBS (Global Banking Systems)
EFD - Bank Direct
Fax

Table 3 shows exemplary client internal systems with which the apparatus and methods of the invention may be used.

TABLE 3
Illustrative Client Internal Systems
Client Internal Systems

Tandem - ECS
Mainframe - Connexion
Info Utility - EIU

Any and all of the aforementioned EDI characteristics may be used as criteria in performing a search for a transaction or associated attachment. For example, a search may be conducted for an EDI transaction having an attachment with a DOC format, transmitted utilizing the Swift FileACT transmission platform. As a further example, a search may be conducted for an attachment associated with an EDI payment to a particular payee on a particular date.

### Searchability Based on Identity of Billpay Intermediaries

The apparatus and methods of the invention may be used in connection with any suitable billpay software, such as Fiserv/CheckFree, by any suitable intermediary offering payment services, such as banks, and by any suitable payment networks, such as PayPal®.

A search for transactions/attachments may be conducted based on the billpay software used to submit a transaction and associated attachment.

### ILLUSTRATIVE EMBODIMENTS

FIGS. 1-7 show illustrative embodiments and features of the invention.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 125 may store software used by server 101, such as an operating system 117, application programs 119, and an associated database 121. Alternatively, some or all of server 202 computer executable instructions may be embodied in hardware or firmware (not shown). As described in detail below, database 121 may provide storage for billpay information, attachments, characteristics of an attachment, transaction data and statistics, and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A client of a financial institution may use a terminal such as 141 or 151 to utilize a billpay platform administered by an intermediary. The client may communicate with the intermediary using a transmission platform such as one of those listed in Table 2. Billpay information, including payee information, payor information, historical transaction records, data objects for attachment, and any other suitable information, may be stored in memory 125. Applications 119 may include a payment origination module such as one of those listed in Table 1.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

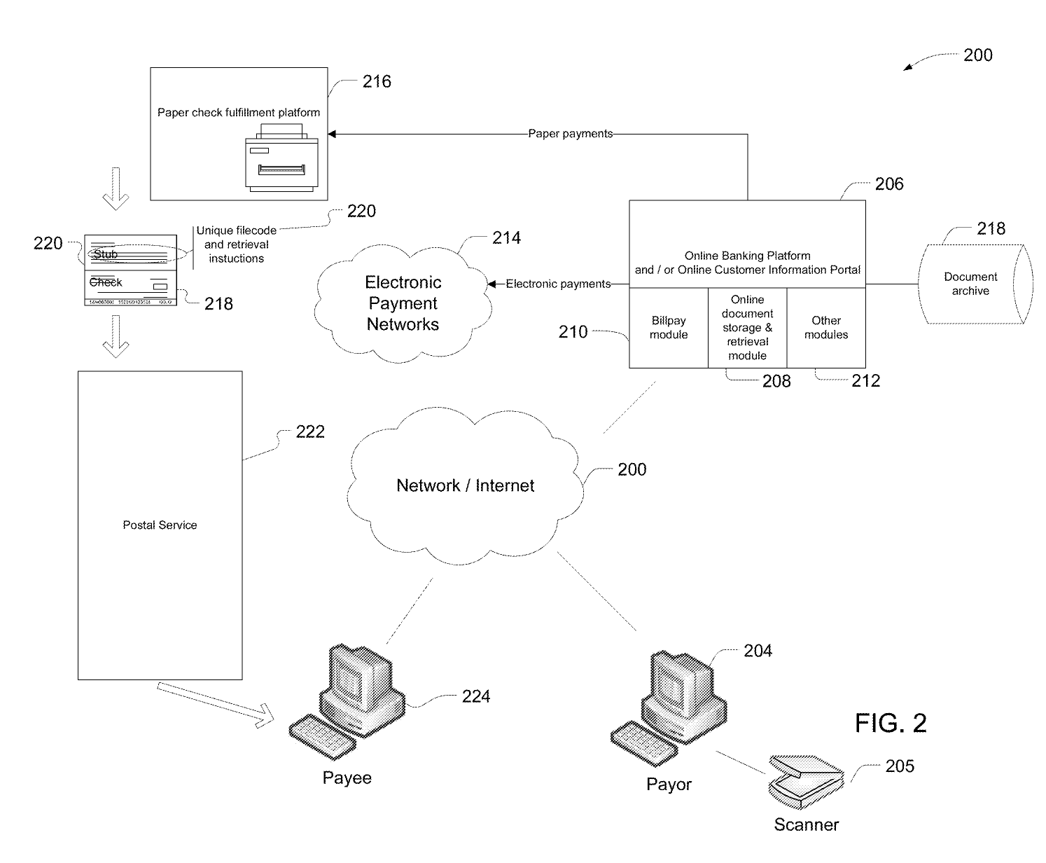

FIG. 2 shows illustrative network 200. Illustrative network 200 may be based on Internet 202 or any suitable communication network. A payor may use workstation 204 to make an online payment. The online payment may be made by transmitting instructions to online banking platform and/or online customer information portal 206. The payor may attach a data object, such as an electronic document, to an electronic record of the payment. The document may be attached from a storage medium that is in direct communication with workstation 204 or from a peripheral attached to workstation 204 such as scanner 205.

In some embodiments, the document may be attached from a storage medium that is in direct contact with platform/portal 206. For example, the document may be stored in online document storage and storage and retrieval module 208. Online document storage and retrieval module 208 may include any suitable storage media. The storage media may include long term storage media for archiving documents. The storage media may include short term storage media for facilitating storage and retrieval of documents during a limited period of time. Online document storage and retrieval module 208 may include any suitable database engine to file and retrieve documents. Online document storage and retrieval module 208 may include any suitable database server to provide documents to a payor. Information processed by online storage module 208 may provide criteria for searching for a transaction and/or an attachment.

Platform/portal 206 may include billpay module 210. Billpay module 210 may include a suitable web server for providing billpay data exchange between platform/portal 206 and workstation 204. Platform/portal 206 may include other modules 212. Other modules 212 may include modules for executing payments. For example, other modules 212 may interface with electronic payment networks 214. Other modules 212 may transmit to electronic payment networks 214 attached documents or linking information regarding the documents in connection with payment information.

Other modules 212 may interface with paper check fulfillment platform 216. Other modules 212 may transmit to paper check fulfillment platform 216 copies of attached documents or copies of linking information regarding the documents in connection with payment information.

Other modules 212 may include modules for storing documents in document archive 218.

Paper check fulfillment platform 216 may print paper check 218. Stub 220 may be attached to check 218 or included in a mailing envelope as a separate sheet with check 218. Stub 220 may include printed information. The printed information may include a unique file code number. The file code number may identify a file that includes transaction information. The transaction information may be stored in platform/portal 206. The transaction information may be stored in document archive 218. The transaction information may include a document that the payor attached to the transaction. The transaction information may include a link to a document that the payor attached to the transaction. The printed information may include instructions for the payee that instruct the payee how to retrieve a copy of the attached document.

Paper check fulfillment platform 216 may include computer-based and/or human-based systems for routing check 216 to postal service 222. Postal service 222 may deliver check 216 to a payee. The payee may use workstation 224 to retrieve an attached document from platform/portal 206. The payee may use workstation 224 to attach a document to a transaction in platform/portal 206.

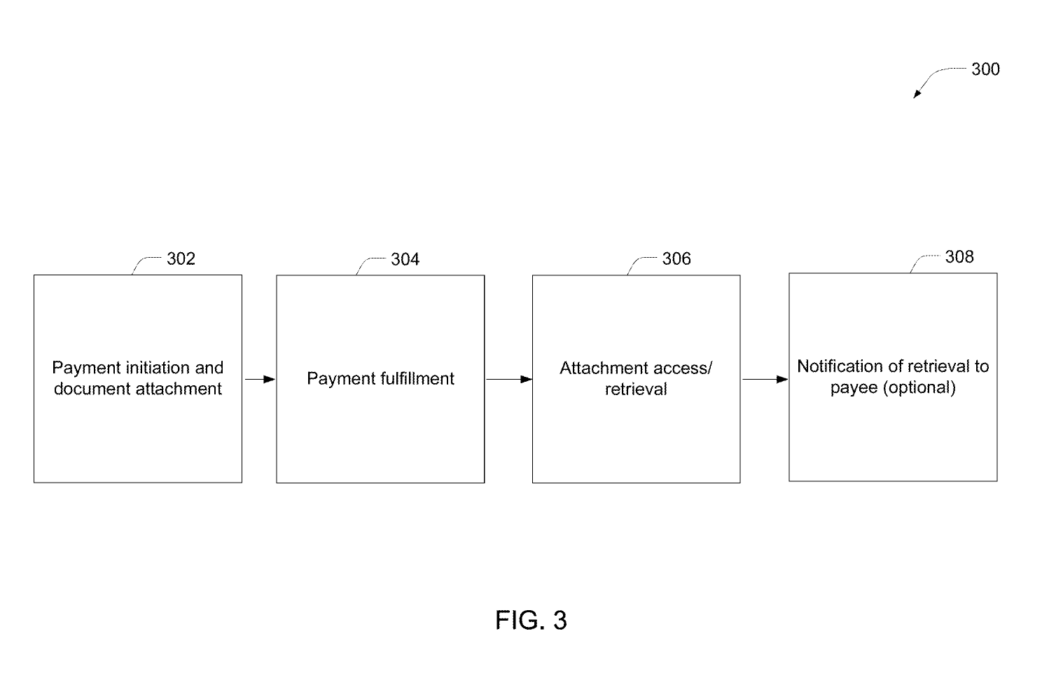

FIGS. 3-7 show illustrative processes. For the sake of illustration, the process will be described as being performed by a system. The system may include one or more of the devices shown in FIGS. 1 and 2, one or more individuals and/or any other suitable device or approach.

FIG. 3 shows illustrative process 300 for attaching a document to a payment. The payment may be part of a transaction between parties such as a payor and a payee. At step 302, a payor may initiate an electronic payment and attach a document to the payment. The payment may be made by issuing a request that an online billpay platform such as 206 issue a payment to a payee. At step 304, the system may fulfill the payor's request by transmitting a check or funds to the payee. At step 306, the attachment is accessed/retrieved by one or more of the parties. At step 308, the payee is optionally notified that the payor has accessed/retrieved the attachment.

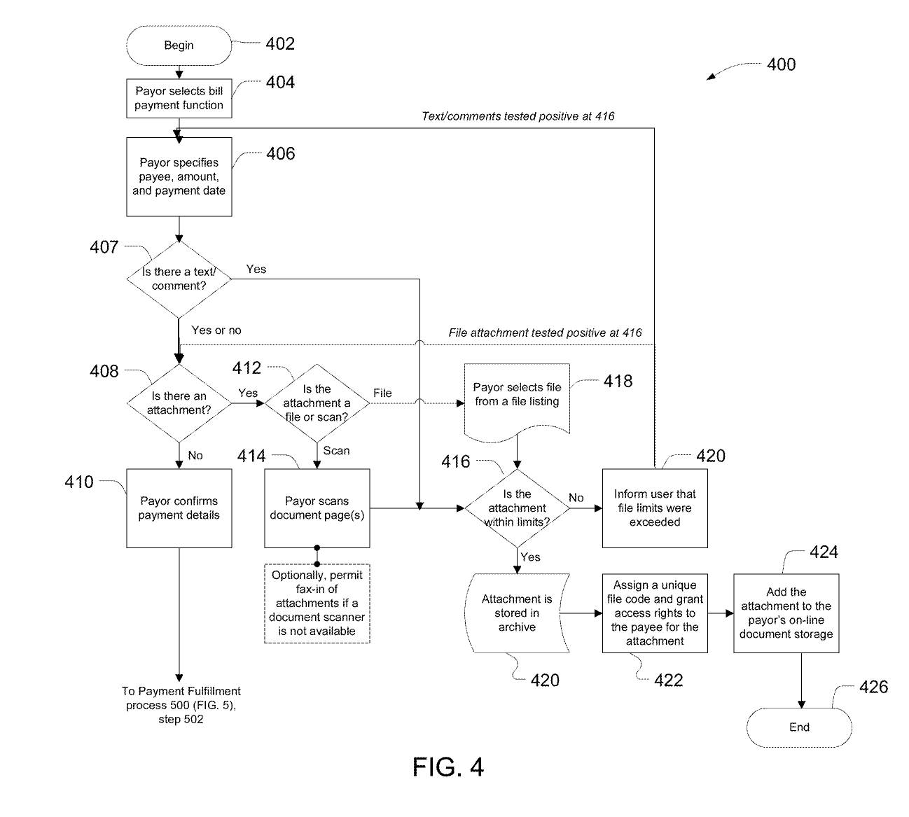

FIGS. 4-6 show illustrative processes 400, 500 and 600, respectively. Each of processes 400, 500 and 600 may correspond in whole or in part to one of the steps in process 300.

FIG. 4 shows illustrative payment initiation process 400. Process 400 may correspond in whole or in part to step 302 (shown in FIG. 3). The payment may be executed by a payor. The payor may be a client or customer of an intermediary. The intermediary may be, for example, a bank or an electronic billpay service. The intermediary may provide an intermediary payment platform, such as that associated with platform/portal 206 (shown in FIG. 2), for use by the payor.

In process 400, the payor may identify the payee, a payment amount and a payment date. If the payor desires to include an attachment in the payment, the payor may select whether to scan a paper document or attach an electronic document. In some embodiments, the document may be scanned using methods shown and described in co-pending, commonly-assigned U.S. patent application Ser. No. 11/755,543, entitled “Secure Session for Document Scanning”, filed May 30, 2007, which is hereby incorporated herein by reference in its entirety.

The intermediary platform may check to see if the attachment conforms to limits. The limits may be limits of attachment size, content, file type, etc. The intermediary platform may use content-, virus-, or digital rights-, or malware-checking software to check the attachment for inappropriate content or malicious code. The intermediary platform may include a module for testing whether the attachment includes content that is appropriate within the context of the payment.

If the intermediary platform deems the attachment acceptable, the attachment may be archived. The intermediary platform may assign to the attachment a unique file code. The unique file code may be a public key. In some embodiments, if the payee is also a client or customer of the intermediary, the intermediary may grant access rights to the attachment to the payee. The attachment may be logged in an online document storage repository in an account designated for the payor. The repository may correspond to document archive 218 (shown in FIG. 2). The repository may be accessible through an online portal, such as that associated with platform/portal 206. The repository may include features that are associated with an e-vault, v-safe or an electronic file drawer.

The steps of process 400 are now described in more detail. The process may begin at step 402. At step 404, the payor may select a function for paying a bill. At step 406, the payor may enter data specifying a payee, a payment amount and a payment date, as well as optional text/comments. At step 407, if the payor has entered text/comments, process flow may move to step 416 where the system may apply one or more limit or content checking algorithms to the text/comment document. At step 416, algorithms may return positive test results on the text/comments, such as length of comments or unsuitable language content. If step 416 returns a positive result, process flow may continue to step 420 where the payor is notified of the test result. The process flow may then cycle back to step 406 for the payor to re-enter or skip the text/comments. Alternatively, step 416 may automatically redact unsuitable language or truncate the text/comments and continue flow directly to step 408. The text/comments and attachments are not considered mutually exclusive, rather, it is anticipated that complementary text/comments and file attachments may be commonly used by payors in their transactions with payees.

At step 408, the system may inquire of the payor whether there is an attachment.

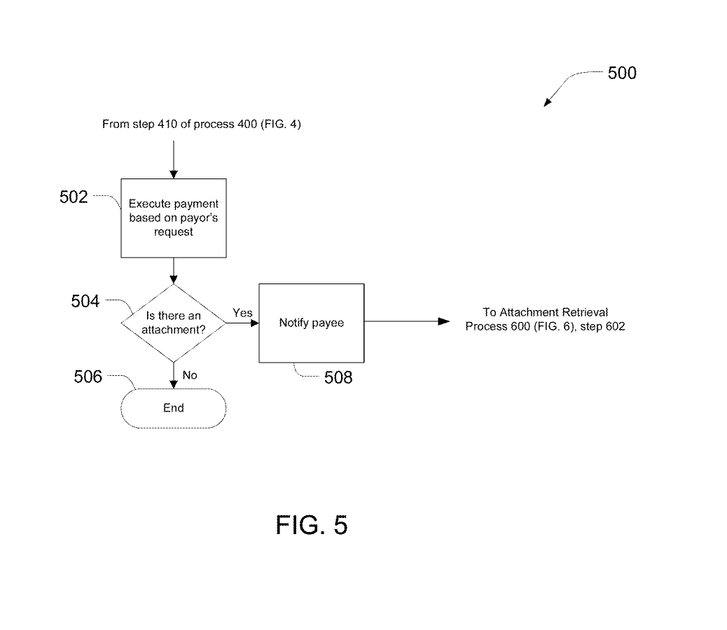

If the payor does not have an attachment, process 400 may continue at step 410. At step 410, the payor may confirm payment details from preceding steps. Process flow may then switch to payment fulfillment process 500 (shown in FIG. 5).

If the payor does have an attachment, process 400 may continue at step 412. At step 412, the system may inquire of the payor whether the attachment will originate from a scan or an electronic file in storage. If the document is to originate from a scan, process 400 continues at step 414. At step 414, the payor may scan a paper document using an appropriate scanning device. Step 414 may include the use of a fax machine to capture the content of the paper document. After step 414, process 400 may continue at step 416. At step 416, the system may apply one or more limit or content checking algorithms to the attached document.

If, at step 412, it is determined that the attachment is to originate from an electronic file, the system may provide the payor with a list of files from which to choose a file to be attached. The payor may select the file to be attached. Files may be resident on a storage medium that is in direct communication with workstation 204 or in online document storage/retrieval module 208 or in document archive 218. Process 400 may then continue at step 416, as described above.

At step 416, if a limit test or a content test has a positive result, the process 400 may continue at step 420. Examples of positive results include: the attachment exceeds a size limit; the attachment includes a virus; the attachment contains digital rights management instructions preventing duplication/distribution; and/or the attachment includes inappropriate subject matter. At step 420, the system may inform the payor of the positive result. Process 400 may then revert to step 408. At step 408, the payor will have an opportunity to attach a different document.

At step 416, if the limit or content tests have only negative results, process 400 may continue at step 422. At step 422, the system may store the attachment in an archive. At step 424, the system may assign a unique file code to the attachment and grant access rights to the payee. When the payee is a client or customer of the intermediary, step 424 may involve provision of a public key to the payee. At step 426, the system may add the attachment to the payor's on-line document storage records. For example, the system may add the attachment to an index of stored documents that are associated with the payor.

Process 400 may end at step 428.

FIG. 5 shows illustrative payment fulfillment process 500. Illustrative payment fulfillment process 500 may correspond in whole or in part to step 304 (shown in FIG. 3). Payment fulfillment process 500 may be performed in connection with a billpay platform. The billpay platform may have one or more of the features that are present in platform/portal 206 (shown in FIG. 2). The billpay platform may be used by the intermediary to effect payment in conformance with the payor's request (e.g., to the designated payee, in the designated amount and on the designated date).

The billpay platform may pay the payee via paper check. The billpay platform may make an electronic payment through a third-party payment network, such as the Automated Clearing House (“ACH”), SWIFT, or any other suitable third-party arrangement. The billpay platform may make payment via entry in a general ledger of an entity to which both the payor and the payee belong (e.g., from one customer to another customer in a closed-loop payment network, such as PayPal®.) The billpay platform may make payment by any other appropriate electronic method.

If an attachment has been attached to the payment, the billpay platform may notify the payee about the attachment. The billpay platform may notify the payee in any suitable manner. For example, if the payment was made by paper check, the billpay platform may provide a printed public-key file code. The billpay platform may provide a uniform resource locator (“URL”) identifying the location of the attachment on the World Wide Web. The billpay platform may also provide instructions regarding accessing the attachment electronically using the public-key file code. The file code and/or the instructions may be printed on a stub or on a separate sheet of paper included in the payment mailing envelope. The stub may be attached to the check. If the payor has provided text/comments as the sole attachment or as a complement to a file attachment, the text/comments may be provided to the payee in the notification, space permitting according to the means of notification. Alternatively, text/comments may be provided to the payee during a two-step or three-step file attachment retrieval process as incorporated herein.

If the payment was made by electronic means, the public-key file code may be included in a payment message that the billpay platform transmits (either electronically, on paper, or both) to the payee. In some embodiments, the payment message (whether on paper or electronic) may include a URL identifying the location of the attachment. If the payment message is electronic, the billpay platform may provide the payee with an electronic link to the attachment. In some embodiments, the payment message may be transmitted by email. In some embodiments, the payment message may be transmitted by short message service (“SMS”). The payment message may be transmitted by any suitable paper or electronic communication. In some embodiments, the text/comments may be provided directly in the electronic payment message to the payee, space permitting according to industry or party standards.

The steps of payment fulfillment process 500 are now described in more detail. Process control may be transferred to payment fulfillment process 500 from step 410 of process 400 (shown in FIG. 4). After the transfer of control to payment fulfillment process 500, process 500 may begin at step 502. At step 502, the system may make a payment based on the payor's request. At step 504, the system may inquire whether there is an attachment associated with the payment. If there is no such attachment, payment fulfillment process 500 may end at step 506. If there is such an attachment, payment fulfillment process 500 may continue at step 508. At step 508, the system may notify the payee about the attachment. If the payee is a recipient of EDI data from the intermediary (an “EDI recipient”), notification and attachments may be aggregated from multiple payors into a single notification and stream of attachments. If the attachment incorporates text/comments, the notification many include the text/comments directly, space permitting according to industry or party standards. Alternatively, the text/comments can be provided to the payee during the attachment retrieval process 600.

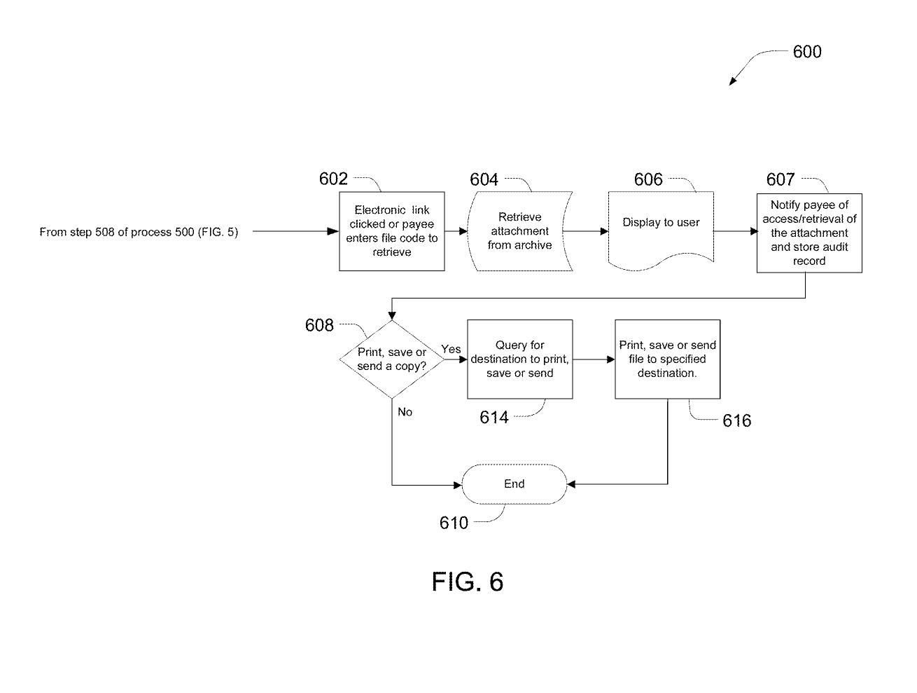

FIG. 6 shows illustrative attachment retrieval process 600. Attachment retrieval process 600 may correspond in whole or in part to step 306 (shown in FIG. 3). In attachment retrieval process 600, the system may provide access to the attachment(s) to the payor, the payee or both. In some embodiments, the access may be provided upon request by the payor. In some embodiments, the access may be provided upon request by the payee. The system may provide appropriate access and authentication protocols to restrict the access to authorized users only. The system may retrieve an attachment from an archive such as document archive 218 (shown in FIG. 2). The system may display the attachment to a payor, payee or another individual using, e.g., workstation 204 or workstation 224 (shown in FIG. 2).

In some embodiments, the system may include modules for printing the attachment, saving the attachment (e.g., at a workstation such as 204 or 224 (shown in FIG. 2)), or sending the attachment to a location or address, whether physical or electronic. In some embodiments, the system may include a module for authenticating copies of an attachment that originated from the document archive. Authenticated attachments may indicate that the archive is a trusted source.

The steps of attachment retrieval process 600 are now described in more detail. Process control may be transferred to attachment retrieval process 600 from step 508 of process 500 (shown in FIG. 5). After the transfer of control to attachment retrieval process 600, process 600 may begin at step 602. At step 602, the system may receive from a user, e.g., the payee, a request for an attachment. The request may be made by a mouse click on a link. The request may include a file code corresponding to the attachment. At step 604, the system may retrieve the attachment from the archive. At step 606, the system may display the attachment to the payee. At step 607, the system may notify the payor of access/retrieval of the attachment, such notification being by any suitable means—paper, electronic or otherwise. Notification audit records may be stored by the system for future audit trail reporting. If the payor is an EDI recipient, the system may notify the payor of access/retrieval of the attachment by the payee on the day of payment when all attachments for the EDI recipient were transmitted. Audit-trail reporting for the payor may include indications provided in a transaction history or statement, reported in either detailed or summary formats.

At step 608, the system may inquire whether the payee wants to print, save or send a copy of the attachment. If the payee indicates that he does not want to print, save or send the attachment, attachment retrieval process 600 may end at step 610. If the payee indicates that he does want to print, save or send the attachment, attachment retrieval process 600 may continue at step 614. At step 614, the system may query the payee for destination information for printing, saving or sending. The destination information may include, for example, an operating system path, a filename, a printer name, an email address or any other suitable destination information. At step 616, the system may print, save or send the attachment in conformance with the destination information received at step 614. Attachment retrieval process 600 may then end at step 610.

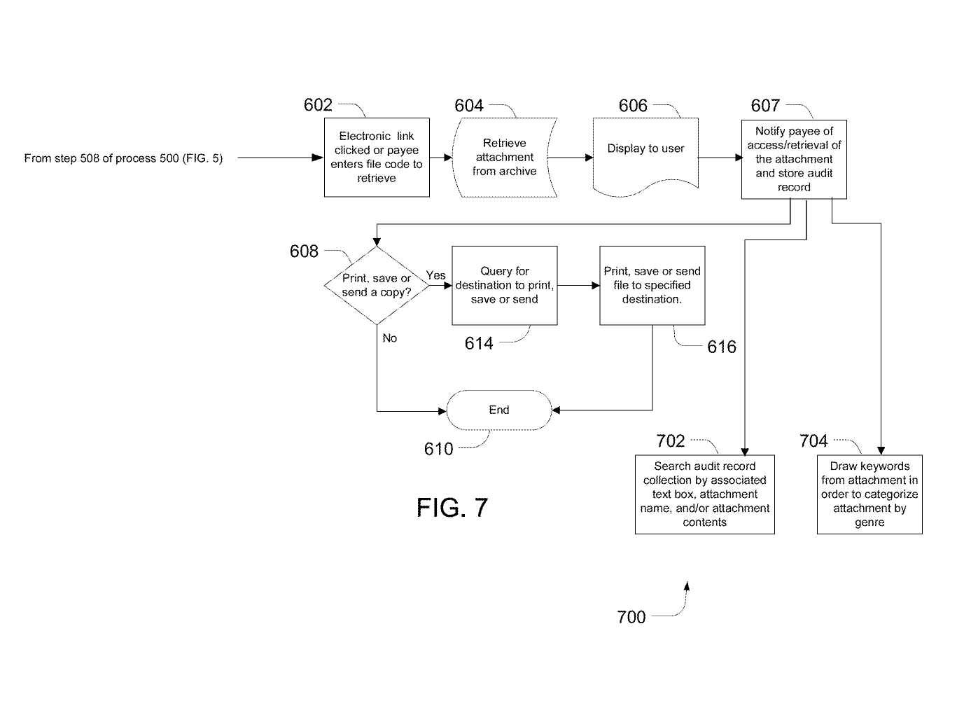

FIG. 7 shows illustrative audit field storage and association process 700. Process 700 includes step 702, which shows searching an electronic audit record collection by a text box associated with an attachment, by an attachment name, and/or by attachment contents.

Step 704 includes extracting keywords from of the attachment in order to categorize the attachment according to genre. For example, attachments may be categorized by such terms as “invoice,” “voucher,” “bill,” “vendor,” etc. Accordingly, a user wishing to search for a particular attachment may narrow his search using genre. Such a search may preferably retrieve all attachments related to a keyword. In addition, a user may narrow the search among the attachments using one or more of the searchable fields described hereinabove.

### CONCLUSION

Aspects of the invention have been described in terms of illustrative embodiments thereof. A person having ordinary skill in the art will appreciate that numerous additional embodiments, modifications, and variations may exist that remain within the scope and spirit of the invention.

One of ordinary skill in the art will appreciate that the apparatus features described herein and illustrated in the FIGS. may be arranged in other than the recited configuration and that one or more of the features may be optional. Also, the methods described herein and illustrated in the FIGS. may be performed in other than the recited order and that one or more steps illustrated may be optional. The above-referenced embodiments may involve the use of other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for attaching information to an online bill payment have been provided. Persons skilled in the art will appreciate that the present invention can be practiced by other than the described embodiments, which are presented for purposes of illustration rather than of limitation, and that the present invention is limited only by the claims that follow.

What is claimed is:

1. One or more non-transitory computer-readable media storing computer-executable instructions which, when executed by a processor on a computer system perform a method of providing enhanced searchability of an attachment associated with a transaction between a payor and a payee, the method comprising:
receiving an electronic request from the payor requesting that funds be transferred to the payee;
receiving the attachment from the payor, the attachment being submitted by the payor for inclusion in the transaction;
storing a characteristic of the attachment in a searchable database; and
receiving a search query for the attachment based on the characteristic.

2. The media of claim 1 wherein the characteristic is a sequence of letters in a file name of the attachment.

3. The media of claim 1 wherein the characteristic is a file extension of the attachment.

4. The media of claim 1 wherein the characteristic is an image pattern of the attachment.

5. The media of claim 1 wherein the characteristic a sequence of characters within the attachment.

6. The media of claim 1 further comprising reformulating the electronic request as an Electronic Data Interchange (“EDI”) record, the EDI record comprising one or more transactions of a plurality of payors to a single payee.

7. The media of claim 6 wherein the characteristic is a payment network origination module format.

8. The media of claim 6 wherein the characteristic is a client transmission platform.

9. The media of claim 1 wherein the characteristic is a limit on an attribute of the attachment.

10. The media of claim 9 wherein the limit is a size of the attachment.

11. The media of claim 1 wherein the characteristic is a result of a scan of the attachment for malware.

12. The media of claim 1 wherein the characteristic is a result of a scan of the attachment for a digital rights violation.

13. The media of claim 1 wherein the characteristic is a result of an analysis of the attachment for content relating to the context of the transaction.

14. The media of claim 1 wherein the characteristic is an authentication of the attachment.

15. The media of claim 1 wherein the characteristic corresponds to an action taken in response to a notification transmitted to the payee, the notification informing the payee of receipt of the attachment.

16. The media of claim 15 wherein the action is accessing the attachment using a secure link in the notification.

17. A system for providing enhanced searchability of an attachment associated with a transaction between a payor and a payee, the system comprising:
a receiver device configured to receive from the payor:
an electronic request requesting that funds be transferred to the payee; and
the attachment being submitted for inclusion in the transaction;
a searchable database designed to store a characteristic of the attachment; and
a processor device configured to search for the attachment based on the characteristic.

18. The system of claim 17 wherein the characteristic is a geographic location of a device used to perform an electronic document capture of the attachment.

19. The system of claim 17 wherein the characteristic is a fillable field in an attachment in a PDF format.

20. The system of claim 17 wherein the characteristic is content of the attachment.
